(19) United States
(12) Patent Application Publication
(10) Pub. No.: US 2015/0261934 A1
(43) Pub. Date: Sep. 17, 2015

(54) System and Method for Providing Pharmacy Services

(71) Applicant: Roby Miller, Iowa City, IA (US)

(72) Inventor: Roby Miller, Iowa City, IA (US)

(21) Appl. No.: 14/211,902

(22) Filed: Mar. 14, 2014

(51) Int. Cl. G06F 19/00

(52) U.S. Cl. CPC G06F 19/3456; G06F 19/322; G06F 19/3418

(57) ABSTRACT

The comprehensive and controlled web-based system facilitates provision of pharmaceutical care and dispensing of medications to patients. The system includes multiple retail or pharmacy outlets whose prescription filling activities are supervised and verified by pharmacists at remote sites. The supervision includes visual confirmation by images for the prescription and the drug dispensed and systematic provision of information pertaining to drug interactions and instructions with affirmative patient confirmation. The system ensures patient safety and education, prescription accuracy, and reduction of expense while assisting rural or economically challenged areas to retain local access to pharmacy services.

### PRIORITY INFORMATION

This application claims priority of U.S. Provisional Application No. 61/801,075 filed with the US Patent and Trademark Office on Mar. 15, 2013, the entire contents of which is herein incorporated by reference.

### FIELD OF THE INVENTION

The present invention relates generally to provision of pharmacy services and, more specifically, to the intersection of electronically facilitated services providing accurate, legal, and efficient pharmacy services to a patient remotely located from the pharmacist or balancing the need for pharmacist on site for prescription verification between stores.

### BACKGROUND OF THE INVENTION

The invention relates generally to health care management and more particularly to the provision of pharmaceutical services related to order management by facilitating provision of services by a pharmacist remotely located from the patient.

Remote pharmacy systems are known in the art. Existing community pharmacy systems have attempted to distribute pharmaceutical care and medications through the use of telecommunications and information technologies via hospital and institutional settings, but have not been fully developed to serve the needs of retail pharmacies.

Like other businesses in small communities, a retail pharmacy in a rural community serves a definite and obvious need by providing access to particular products and services otherwise not available. Equally as important, a rural pharmacy provides convenience to residents and participates in the economic health of the community itself. But, retail pharmacies in small towns and rural settings face specific challenges related to maintaining viable business outcomes:
1) A rural community pharmacy struggles to grow its business and continue providing adequate care and relevant medications to patients it serves due to decreasing Medicaid reimbursement rates in many states. Medicare Part D shifts the method of payment for prescription to a third party, resulting in declining retail profit margins. Unlike large chains, an independent retail pharmacy cannot absorb this loss nor can it counter it with non-pharmaceutical sales. When a rural pharmacy is not able to find ways to lower costs to providing services it closes. The closure of a rural pharmacy leaves a distinct and very real need unmet in a community and rural patients are disadvantaged by this limitation in access to pharmaceutical services.
2) In order to maintain an independent retail pharmacy, the business must generate enough revenue to maintain a pharmacist on staff. In rural settings, this can prove difficult.
3) When pharmacies close, patients are forced to drive to larger settings for pharmaceutical service access. As a result, patients tend to carry out other business transactions in that larger setting including physician care. As patients access and make purchases of goods and services away from home, the impact goes beyond health care to a broader economic issue,
4) Critical access is an additional concern. The poverty level of many patients in rural areas impacts their ability to drive far distances in order to access pharmaceutical care and medications.

A group of pharmacies may be managed by a single entity and/or owned by a single entity, whether rural or not. These pharmacies may have periodic patient loads that make having a full time pharmacist on staff unaffordable or that make having more than one on staff at the same time unreasonable, but keeping patient customers waiting is equally undesirable. Alternatively, given the appropriately constructed communication system, a single licensed and registered pharmacist could conceivably provide services to more than one pharmacy located remotely from each other and from the pharmacist.

There are some options for provision of pharmacy services to patient remotely located from the pharmacist, in rural towns or other places whether a pharmacist is not present. For example, although they are still evolving, telemedicine systems are becoming ever more possible. They strive to provide a complete system that ensures a secure, controlled environment for the distribution of pharmaceuticals but have, to date, fallen short. For example, these telemedicine systems provide incomplete visual identification systems allowing for errors to occur. Further, there is no connectivity to a central pharmacy management system creating incomplete record keeping which is critical for achieving a more secure controlled telemedicine system with adequate continuity, verification, documentation, confidentiality, and record management. In addition, these systems are typically unable to ensure timely and correct delivery of products due to software limitations. And most of these systems have not addressed the issues caused by a lack of easily accessible patient consultation and education with a registered pharmacist. Finally, these systems have not been designed to allow for employment of multiple pharmacists to serve multiple remote locations, rather to allow a pharmacist to serve remotely.

Challenges to telemedicine systems remain that could result in significant legal liability within the pharmaceutical industry and economic challenges to communities. But, without a community pharmacy option, the loss of access to vital healthcare services for patients living in rural communities becomes a reality. The same holds true for patients requiring a pharmacist's consultation when one is unavailable due to workload. Without complete services, patients can more easily experience drug overdose, adverse reactions due to multiple drug interactions, and medication errors.

### SUMMARY OF THE INVENTION

The present invention comprises a community pharmacy solution which improves pharmaceutical healthcare services while reducing medical and labor costs, provides access to pharmaceutical care and medications to rural patients in community pharmacy settings, or to patients that would otherwise have to wait unreasonable amounts of time based on pharmacy order loads, reduces human errors, and increases accuracy. In addition, the invention improves the efficient use of licensed pharmacists by providing the means for one licensed and registered pharmacist to serve multiple locations at the same time while being remotely located in another building, another town, or another state; or several pharmacists to share responsibility for multiple pharmacies concurrently. The invention also embodies tools which provide solutions that fit a pharmacy of any size and prescription volume and provides detailed, retrievable records for every prescription filled. As an additional feature, pharmacy owners can remotely monitor their employees' productivity and accuracy, as well as the efficiency of all their pharmacies through real-time analytics (and also add to a pharmacy's efficiency). The system provides deep integration with existing pharmacy management systems ensuring the most accurate and up-to-date patient information while increasing workflow capacity. More specifically, the invention relates to increasing safety of dispensing prescription medications through community pharmacy services by providing alerts for duplicate therapy, drug interaction alerts and allergies notifications.

The system preferably includes a remote verification and web-based workflow software that pulls data from multiple sources in order to generate and record unique prescription data. The prescription data may include verification by a bar code verification system and documentation by digital photographs that are electronically recorded and preserved. The physician script and the packaging are matched, monitored and verified through video and audio communication between a licensed supervising pharmacist located remotely from a pharmacy technician and the patient and dispensed drugs, including visual identification of the actual drugs by the remotely located supervising pharmacist. The visual identification of the drugs includes employment of a confirmation process by a remote pharmacist. The confirmation process preferably includes a database of drug images for referral and confirmation along with patient data. The patient data includes alerts to duplicate therapies, other drug interaction possibilities, and allergy warnings, and includes an image of the drugs dispensed. The patient data is delivered to pharmacy staff and directly to the patient. Delivery of the prescription to the patient includes education and consultation via the web-based workflow software.

### BRIEF DESCRIPTION OF THE DRAWINGS

FIG. 1 is a schematic overview of the comprehensive system built for remote verification, video consultation, and supervision of community pharmacies using a system web application and cloud storage.

FIG. 2 is a flowchart illustrating a method for remotely verifying, dispensing and counseling remote community pharmacy functions.

FIG. 3 is an illustration showing the system modules and the entirety of the inventive process and data addition from written medication order to each location through the network and system web application.

FIG. 4 illustrates an exemplary image from the system comprising the Pharmacist dashboard displaying the patient verification process for Pharmacists of multiple pharmacies and consultation of those patients from a remote pharmacy.

FIG. 5 shows a Pharmacist verification screen which allows the remote Pharmacist to verify that the Technician from community pharmacies dispensed the proper drugs for the acquiring patient.

FIG. 6 provides an exemplary image Pharmacist consultation screen for the remote Pharmacist to deliver prescription education and warnings to the counseled patient at a community pharmacy site.

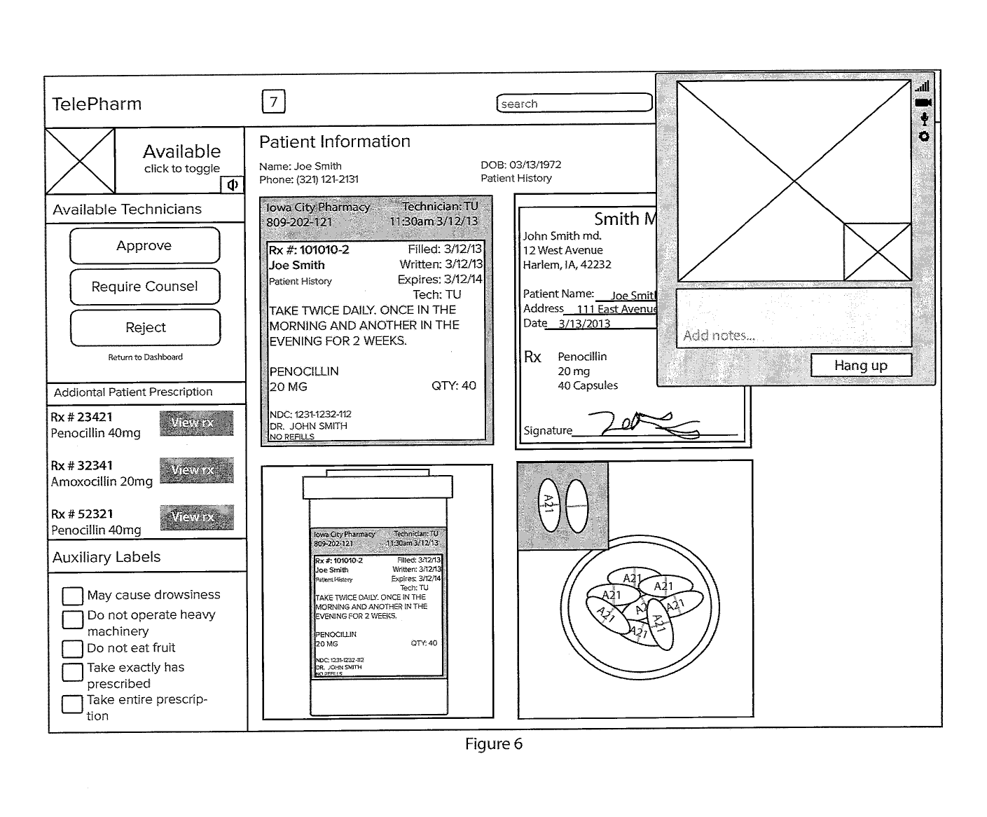

FIG. 7 is an exemplary image Patient drug adherence confirmation screen where Patient is required to acknowledge the warnings, potential reactions, and therapies for a prescription.

FIG. 8 shows Technician-captured required verification images including written medication order, prescription label, and physical drug to be sent to remote Pharmacist for verification.

FIG. 9 is a perspective view of the present privacy kiosk containing the video conferencing platform and audio headset for community pharmacy sites to provide the Patient with a safe and private environment to receive consultation from a remote Pharmacist. This kiosk provides provide counseling within a HIPAA compliant setting via phone.

### DETAILED DESCRIPTION OF THE INVENTION

The present invention provides a complete system for a non-pharmacist in a community pharmacy setting to dispense medication. The system includes a controlled environment connecting a network of one or more remote pharmacists to one or more community pharmacies, combining data to create a unique dataset to improve patient education and drug adherence, and to improve workflow efficiency and accuracy while reducing labor expenses and errors.

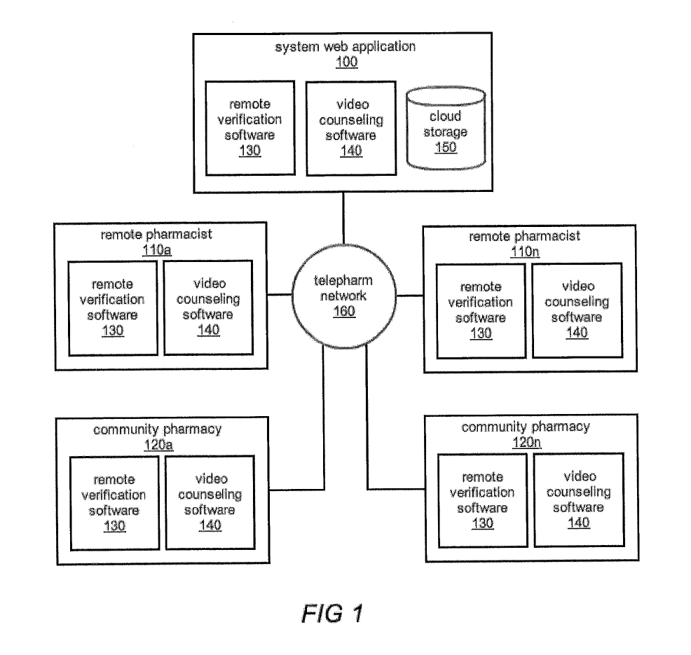

FIG. 1 illustrates the comprehensive HIPAA compliant community pharmacy web application network 160, connecting multiple pharmacists to multiple community pharmacies to provide pharmacy care. The web application enables a non-pharmacist to legally and correctly dispense medication to critical access remote retail pharmacies. The Web-based platform is classified as an ordering system—it is not a Pharmacy Management System, however, it does interconnect to existing Pharmacy Management Systems and can accept and export relevant data from those systems as needed. In FIG. 1 there is shown the system web application 100. Within the system web application is a plurality of functions including: remote verification software 130, video counseling software 140 and cloud storage 150.

The remote verification software 130 and video counseling software 140 provide the systems workflow. The workflow comprises 1) Data entry into the Pharmacy Management System; 2) Label is printed in accordance with said data entry; 3) The drug is prepared. In the cloud storage 150, all records are stored and backed-up, associated with unique identifiers, and an audit trail is maintained and is made accessible for system and pharmacy management.

The system includes a plurality of opportunities for a remote pharmacist to meet the pharmaceutical needs of community pharmacies. At its most basic, the remote pharmacist 110, using the remote verification software 130 and video counseling software 140, serves the needs of one or more community pharmacies also accessing the remote verification software 130 and video counseling software 140. In another embodiment, the system allows for multi-store management by queuing available remote pharmacists and rotating patients at a plurality of pharmacies based on available time. It allows the remote pharmacists to see script count, error rate, and patient wait time for queue management.

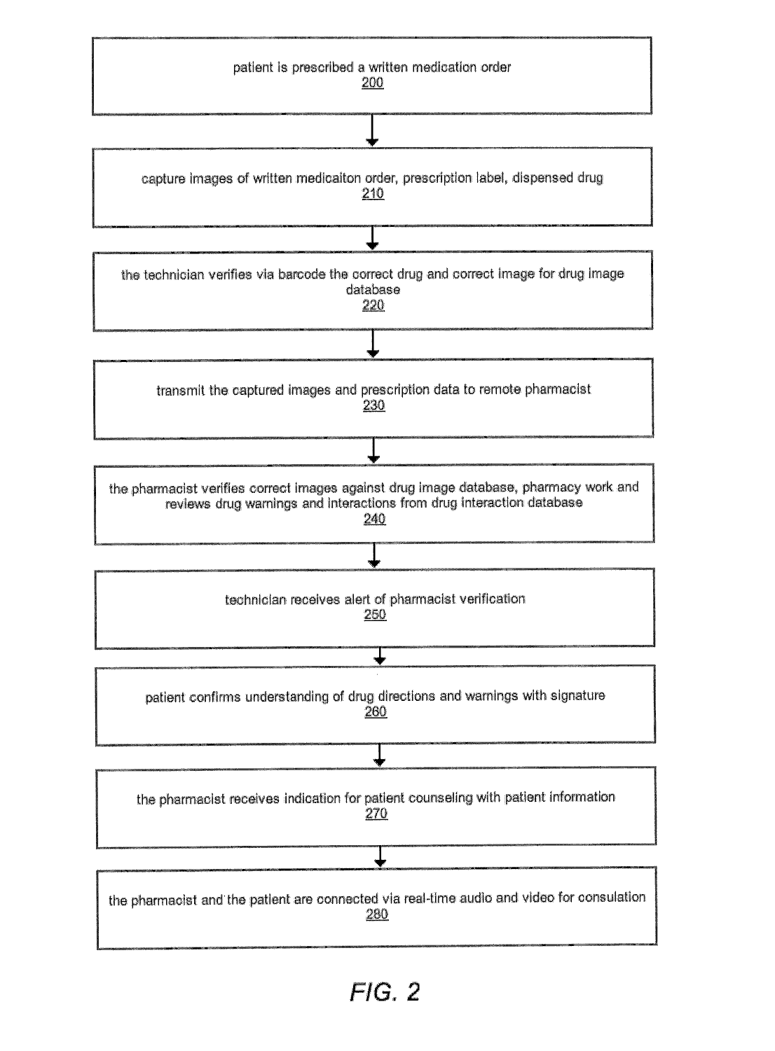

FIG. 2 shows one possible flow of work from entry of the written prescription, or medication order 200, through connection between the remote pharmacist and the patient via real-time audio/visual means 280. This flow may include some additional steps as needed, but should always include a visual review of the medication order and of the medication itself as well as the image for that ordered medication as provided through a standard database. The flow generally follows the steps described in FIG. 2. The order begins when the patient is prescribed a written medication order 200. The script is received by the community/remote pharmacy where the non-pharmacist/technician uses the system to combine Pharmacy Management System prescription data with images captured of the written medication order, prints prescription label via accessing the system database, and dispenses the physical drug 210. At 220, the technician verifies the drug being dispensed is being taken from the correct stock drug bottle by scanning the barcode, matching it with the drug database information for that drug. This provides a second check to accuracy confirmation.

At 230, Technicians capture a digital image of the label and drug dispensed preferably using a high definition inspection camera or other device that captures a detailed image. The technician submits captured images and prescription data to the system storage cloud where, at 240, the images can be viewed by the remote pharmacist who verifies the images: physical written prescription, label and drug image against the system drug image database. All drug interaction, duplicate therapy, and allergy information are pulled from the system database and presented for review by the remote pharmacist. Providing this information prevents potential negative interactions and ensures safety. Based on the review of the physical written prescription, label and drug images, the pharmacist approves or rejects the prescription, and stores this approval or rejection on the system storage cloud. The technician is then notified of the pharmacist's approval or rejection at 250.

The community pharmacy provides the setting for patient access to pharmaceutical care and education at 260, where the patient is asked to confirm his identity using the Pharmacy Management System database, and to acknowledge directions and warnings presented to the patient on the screen. The patient is then required to confirm his understanding with an electronic signature. The electronic signature is received and then stored on the system cloud. The patient is then presented with an option to receive counseling from the pharmacist.

If the patient elects to receive counseling, the remote pharmacist is sent an indication of the need for counseling and the system provides the remote pharmacist with prescription information, directions and warnings 280 for use in providing counsel to the patient. All of the aforementioned data is added to the prescription from the drug interactions database and prescription directions and warnings. The counseling is provided through a unified system with prescription data and video conferencing which pulls and combines information from multiple databases to ensure the most up-to-date and accurate patient information is being provided to the pharmacist to assist and educate the patient. The patient is provided means to see or at least hear the remote pharmacist, and view a screen that includes prescription information, directions and warnings which are pulled by the system from the directions and warnings database then displayed to the patient during the video conferencing counseling session with pharmacist to ensure accuracy of remote dispensing. During the counseling session or near its close, the remote pharmacist will ask or the system will present a screen with a query to the patient asking the patient to read each warning and select an indicator that he has done so therefore obtaining position confirmation.

Each step and each modification of this workflow is recorded by the system cloud storage and is readily retrievable as needed.

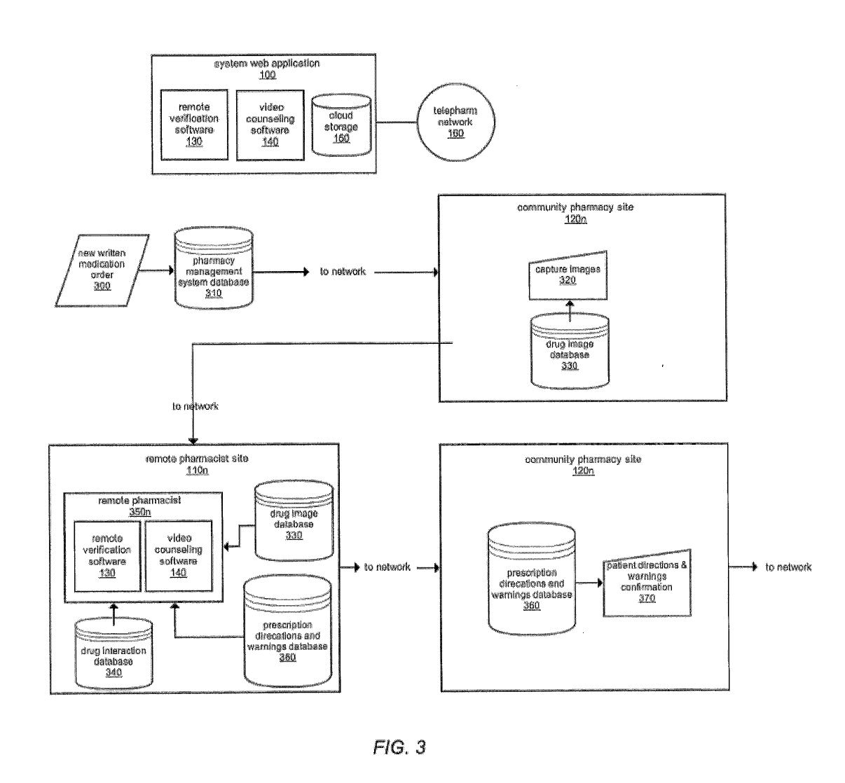

In FIG. 3, the web system application is displayed, specifically concerning the flow and documentation of prescription data. The chart shows how the web application combines a unique analytical dataset to enable a secure pharmaceutical transaction. Specifically, the system's web application draws data from the Pharmacy Management System, a drug database, and the Drug Interaction Database (which includes Drug Allergy, Drug Duplication, and Drug Therapy Database, (130, 140, 150, 160). At 300, a new written medication order enters the system. At the community pharmacy site 120n, the non-pharmacist technician scans the order into the system and captures images of the dispensed medications at 320; followed by a comparison of images against the drug image database at 330 to provide a quality assurance check. Through the secure system network, the non-pharmacist generated images are provided to the remote pharmacist site(s) 110n. The remote pharmacist 350n utilizes the video counseling software 140 and the remote verification software 130 which provides access to and runs the images and information against the drug interaction database 340, provides access to the drug image database 330, and to the prescription directions and warnings database 360 for another quality assurance check.

The network system 100 is tracking and documenting all steps in the workflow as it moves back into the community pharmacy site 120n where the patient receives the prescription directions and warnings 360 information. Upon receipt, the patient confirms the receipt of the prescription directions and warnings 370. Again, this confirmation is documented in the system.

The system web application 100 combines data from Pharmacy Management System 310, Drug Image Database 330, and the Drug Interaction Database 340 which includes Drug Allergy, Drug Duplication information to create a unique dataset that is analyzed to: a) improve drug adherence through patient education (by displaying the uniquely derived dataset to the patient and ensuring the patient acknowledges all drug warnings and directions.); b) improve pharmacy dispensing workflow efficiency (by pulling stored patient information and history, stock prescription drug images, potential prescription drug interactions and allergies, along with potential prescription drug duplicates and therapies.); c) reduce labor expenses through empowering pharmacies to share pharmacist expenses; and d) increase accuracy of the pharmacy process, thereby reducing errors, Utilizing the system features, processes and data in the inventive system increases the safety of pharmacy care through the verification steps and combining databases to analyze prescription warnings. The system enables provision of pharmaceutical healthcare services to critical access patients.

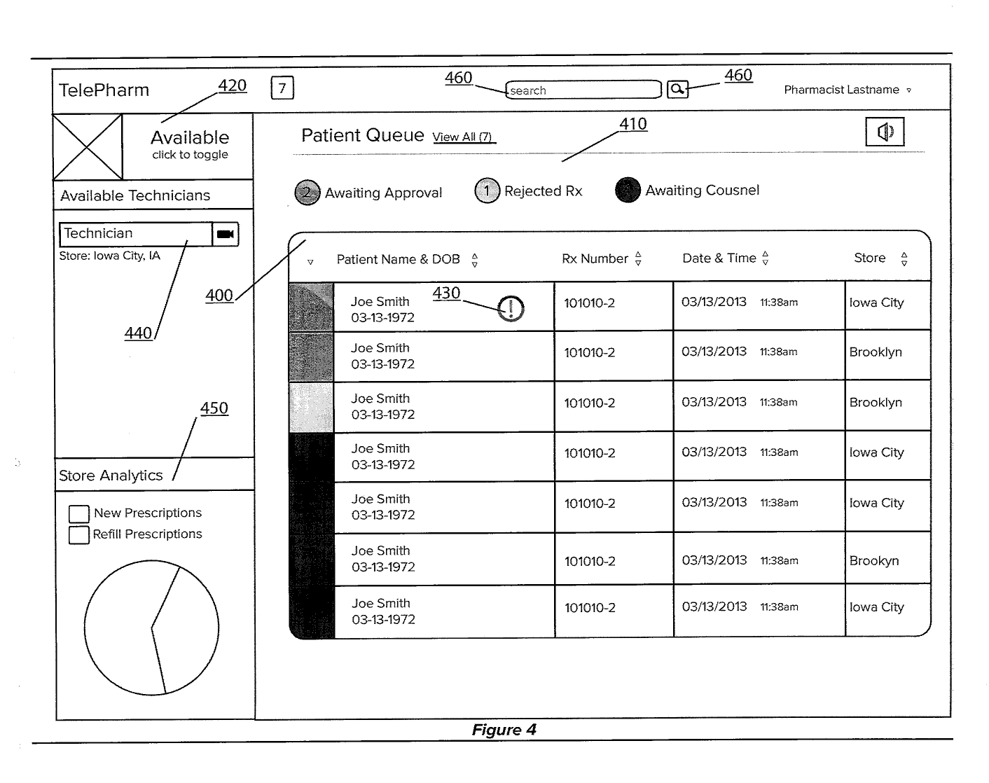

FIG. 4 shows the Pharmacist Dashboard. The verifying Pharmacist uses the system web application and cloud storage for prescription drug verification and to access information necessary to provide counseling services to a patient that may be located at any one of several stores. In short, the system allows access by a pharmacist remotely located at one central pharmacy to all of the uniquely combined Patient datasets, patient history, prescription drug information, and patient consultation information. The remotely located Pharmacist can work off site and still safely verify prescriptions and counsel Patients.

The ability to verify and counsel patients from a remote pharmacy allows the Pharmacist to provide counseling to patients in critical access areas where such counseling and provision of services was not heretofore economically possible. Through the Pharmacist Dashboard, the remote Pharmacist has easy access to the status of every prescription in the workflow and can filter or sort the list of prescriptions by status. The remote pharmacist is instantly notified 430 when a technician establishes a transaction as high-priority; or if the technician posts comments on a prescription, which keeps communications in an open status.

The remote pharmacist is accessible to all technicians that are signed in at any given time 400. The system facilitates video sessions for direct patient contact as well as between pharmacist and technician.

The remote pharmacist can easily search for patients by name, prescription, or prescription number and is provided access to search capabilities to perform advanced searches 460. The system also allows the remote pharmacist or manager to easily see a summary of store analytics 450 including any timeframe of script counts and error rates. This data can be generated for a single pharmacy or for multiple pharmacies within a network.

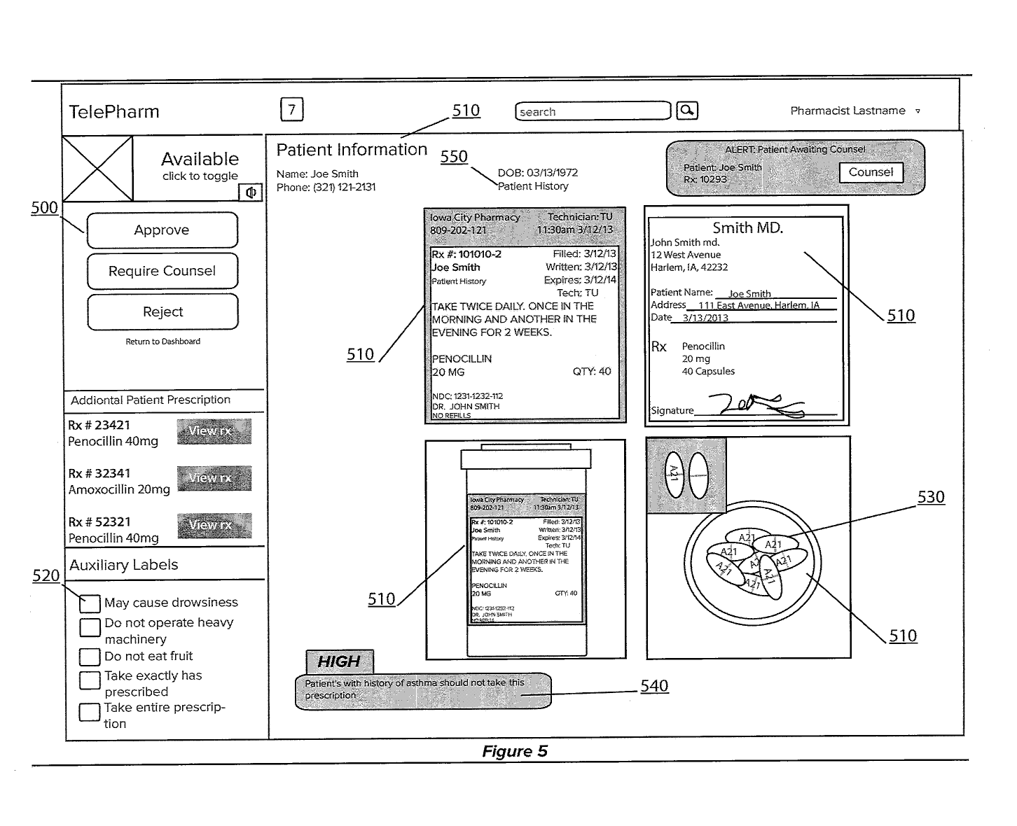

FIG. 5 is an illustration of the Pharmacist Verification Screen. The pharmacist selects from a number of options to require patient counseling, approve prescriptions, or reject prescriptions 500. The current patient's prescription information is available 510. The pharmacist can provide direction by selecting from a number of options. For example, the Pharmacist can direct technicians to apply auxiliary stickers to prescription bottles 520. The pharmacist may access a database of stock drug images and, upon selection of a drug, an image is portrayed 510, 530. This allows pharmacists to verify dispensed drug images with complete accuracy.

From the Pharmacist Verification Screen 510, a Pharmacist is able to view the physician's prescription, the label on the dispenser container, and the image of the dispensed drug. The pharmacist can review a database of drug interactions, side effects, warnings, and/or directions for use related to the prescribed drug or drug which is relayed by the system and alerts the pharmacist, who is able to quickly identify potential issues 540. Alternatively, the pharmacist may query the system for drug interactions, or, perhaps, usage instructions or for side effects. These queries may access separate databases for each, or a comprehensive database containing all. The system also alerts pharmacists to duplicate therapies and to allergies of the patient if any are known and recorded in the stored data resident in the Telepharm cloud storage 550. The pharmacist can view each patient's history which may also be accessed from all the stored data in the TelePharm cloud storage 550.

During a teleconferencing session with the remote pharmacist, the patient will be presented an image that includes that patient's specific prescription and directions along with patient specific data including patient name, address, prescription name, and number to validate the patient that is being counseled. In one embodiment, the session will include a video link with the pharmacist. In another embodiment, the video link is only one direction; in another there is only an audio link.

During the session the patient will be presented with the drug warnings and drug education associated with his prescription, which are pulled from the Drug Interactions database to ensure that all drug adherence information is covered by the verifying pharmacist and understood by the patient.

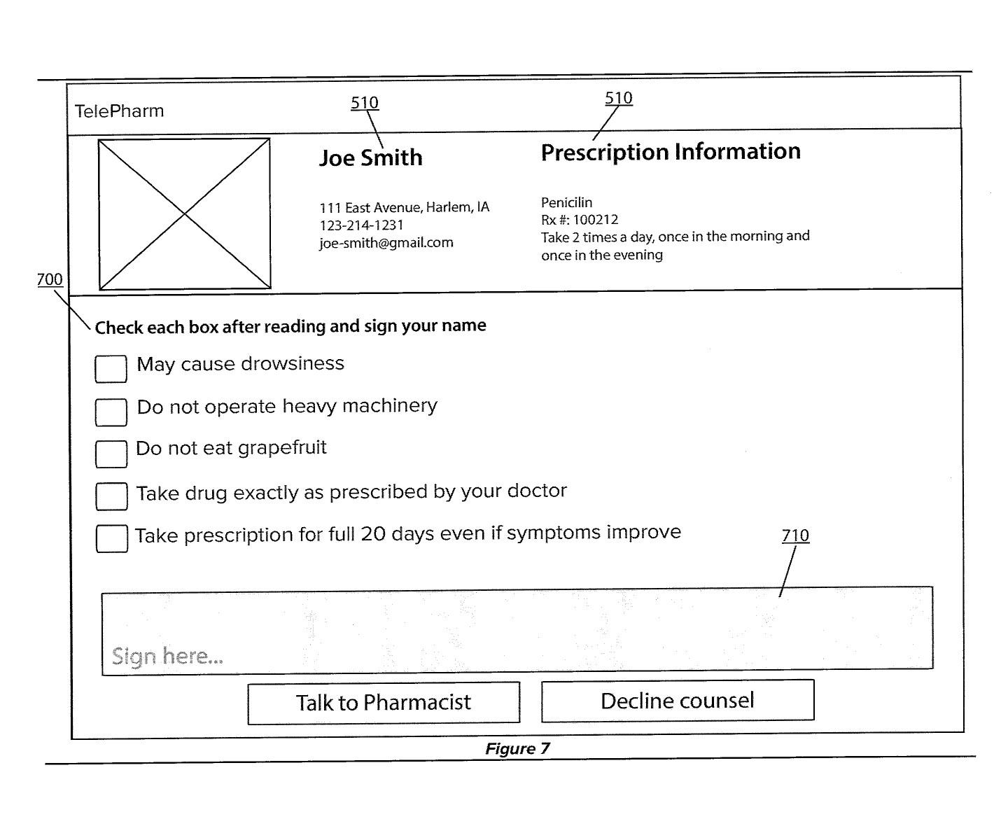

FIG. 7 provides an illustration of the Patient Drug Adherence Check screen. At 700 a patient must acknowledge every direction and warning pertaining to each prescription he is receiving before leaving the Pharmacy. Pulling from the prescriptions interactions and warnings database, the patient is presented with a checklist of directions and warnings associated with taking the prescribed medication. The information preferably includes drug interaction advice, a description of common side effects, and dosing recommendations. In order to receive the prescribed medication from the technician, the patient uses the system to provide indication (such as by selecting and clicking a box) of reading each of the warnings/interactions that have been presented to the patient on the screen. The preferred embodiment requires these acknowledgements in addition to an electronic signature to indicate the patient understands the warnings. At 710 the patient's acknowledgement is then stored in the TelePharm cloud storage, for future retrieval if necessary. The patient's acknowledgements are pushed to the HIPAA compliant web application for the verifying Pharmacist to review during patient consultation. This review ensures that the Pharmacist understands any complications or difficulties the Patient may have with the directions or warnings. The confirmation information is combined 550 with the other data collected throughout the prescription filling process and added to the patient history timeline in the TelePharm cloud storage so the verifying Pharmacist can refer back to this dataset at a future date.

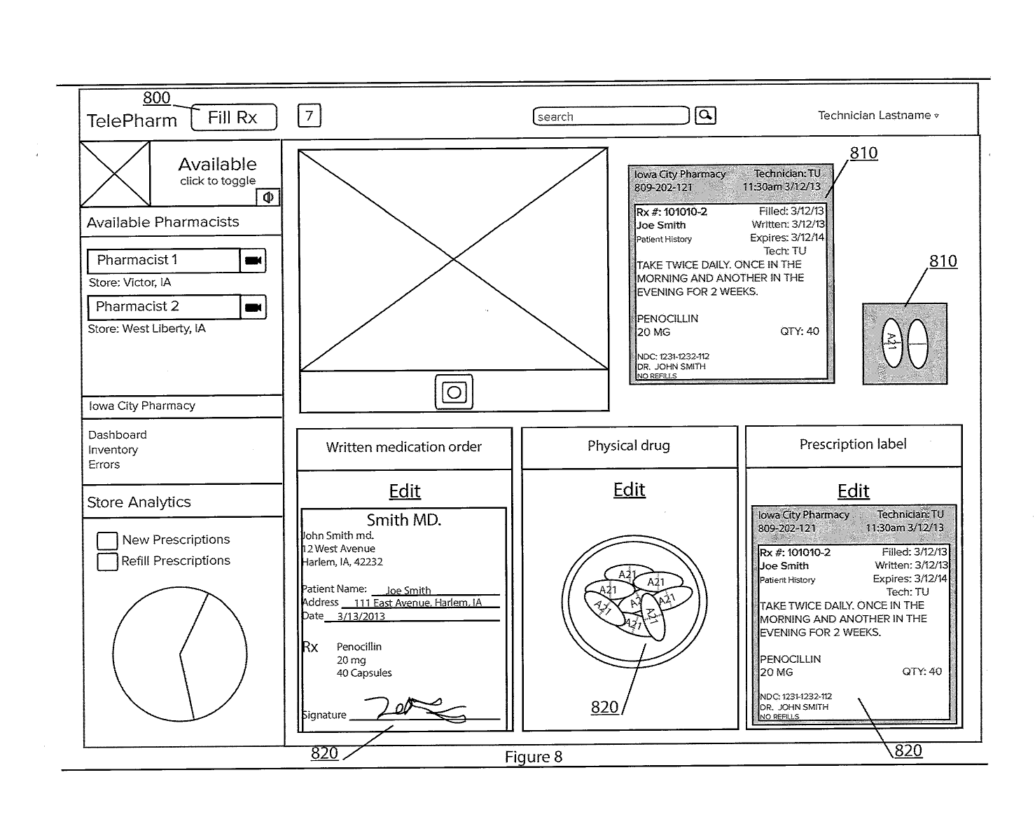

FIG. 8 illustrates the beginning of the process. Here the screen shows that the Technician received the written medication order from the prescribing prescriber 820 and performed data entry into the pharmacy management system 820. The Technician created the data in the form of a label which was also either stored or scanned in as information in the pharmacy management database (and presented to the patient and the remote pharmacist during the counseling session). This information was then pulled from the pharmacy management database into the system web application and stored in the TelePharm cloud storage when the Technician entered the prescription number into the system web application 800. As a means of system integrity, the system web application then communicates to the pharmacy management database that the information has been entered. The system web application then uses the prescription drug details to pull the correct prescription drug stock images, interactions, allergies, warnings, and therapies from the drug interactions database 810. At 820 the Technician captures images of the written medication order, prescription label, and physical drug. Verification of the original physician provided prescription is captured in the system 810. In one embodiment, the Technician may scan the stock bottle to verify the correct drug. This provides a second check for accuracy confirmation. In one embodiment, the Technician captures a digital image of the label and drug dispensed 820 with supplied high definition inspection camera.

The system web application displays the stock drug image from the drug image database next to the physical drug image 810 that the Technician captured; Technician compares to ensure a match. Pulling from the interaction database, the system web application automatically assigns any potential drug interaction, warnings, directions, or therapies associated with the prescription to eliminate the possibility of human error in forgetting to assign designated drug adherence 540. When the Technician submits the prescription to the remote Pharmacist for approval, all data is stored in the TelePharm cloud storage and notifies the pharmacy management database that the prescription has been submitted for pharmacist verification. The complete set creates a unique timeline and dataset for the individual patient and verifying Pharmacist to review and compare patient history to the current prescription.

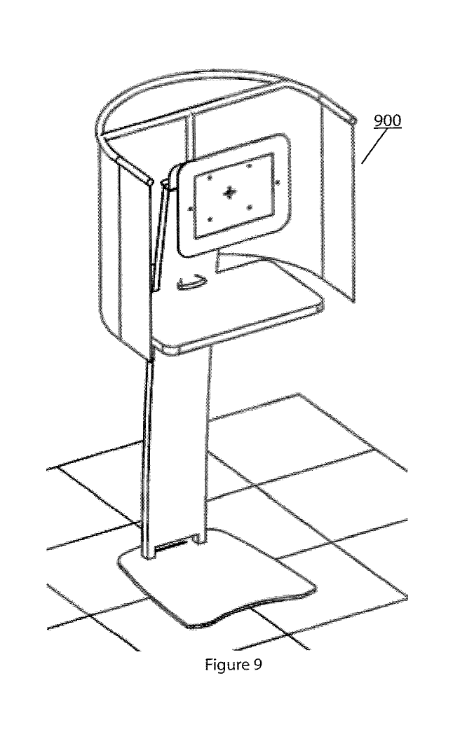

The system is designed to include a patient kiosk 900 one example of which is shown at FIG. 9. The kiosk should be HIPAA compliant and provide at least the same level of privacy required for a pharmacist consultation that would occur in person. Providing patient education and consultation that is completely HIPAA complaint, private and comfortable to the patient can be a key attribute of the inventive system. Illustrated in FIG. 9, the patient kiosk 900 provides a private area for education and consultation. All aspects of the patient/pharmacist interaction occur through a HIPAA Compliant WebRTC connection. When the prescribed medications are prepared and approved by the remote pharmacist, a patient is required to acknowledge the prescription directions. At the patient kiosk 900, the patient accesses a touchscreen tablet or other simply used device electronically associated with the system. The device provides written instructions from the pharmacist which both the patient and the pharmacist can view. At 900, both patient and prescription information is made available, providing one extra step of verification.

The patient must acknowledge his receipt and understanding of the directions before receiving the prescribed pharmaceuticals. A patient enters his electronic signature and/or another confirmation indicator for each individual prescription drug dispensed. The signature or other confirmation indicator is captured on the touchscreen tablet or other device and stored, along with all patient history, information, and prescription in the web application system. The system also documents if the patient accepts or declines counseling (for example, if the prescription is a refill, the patient can decline counseling). If counseling is accepted, the pharmacist is displayed via audio and/or video or via teletype for hearing impaired or by preference. These communications modes are facilitated by the system, including video conferencing technology through the video platform within the browser. This eliminates the need for external, physical video platforms at the remote site or the community pharmacy. Patient and prescription information and video conferencing are preferably tied to one system or dashboard. In one embodiment, patients are provided a mirror image of themselves as they are interacting with the pharmacist, and an audio headset, tied to the system. This allows the patient to speak quietly with the consulting pharmacist.

Because this is a real-time interaction, the pharmacist is able to answer patient questions. The preferred embodiment of the privacy kiosk also has a privacy shield which ensures the patient data security, privacy, and integrity, while providing a comfortable and safe environment for them to speak freely with the consulting Pharmacist. Either patient or pharmacist can end the counseling session with a simple click. An example workflow may be as follows:
1. Physician prescribes medication to patient
2. Prescription is sent to pharmacy via nurse, mall, e-scripting, or patient
3. Technician enters data into Pharmacy Management System
4. Technician prints prescription label
5. System pulls data from Pharmacy Management system
6. Technician captures images of prescriber's order, physical picture of drug and prescription bottle label
7. Technician scans stock bottle barcode to verify correct bottle
8. Technician submits to pharmacist
9. Pharmacist is alerted of prescription to be reviewed
10. Pharmacist views images (from #6) compares to stock image of drug
11. Pharmacist will be alerted of patient allergies, interactions and duplicate therapies
12. Pharmacist can approve or reject prescription.
   a. rejection—technician is alerted and starts at #3 to correct changes
13. If approved, technician is alerted and will package medicine to be dispensed to patient
14. (Patient returns to pick up prescription) Technician initiates tablet for patient to review warnings and directions for prescription
15. Patient will check the boxes for understanding and then signature is digitally captured
16. Patient can accept counseling by pharmacist or decline counseling a, accepted—
   i. pharmacist is alerted of video conferencing call
   ii. when call is answered, pharmacist views the prescription information and consulting directions for patient
   iii. patient and pharmacist can talk to each other via real-time video/audio link b, declined
   i. prescription is completed
   ii. prescription history are readily available to view information

The advantages to the present invention include, without limitation, a web-based platform, improved accuracy facilitated by the system dashboard which allows the board of pharmacy to watch over the community pharmacies, providing more accountability and protection from abuse at the community pharmacy locations. It allows for real time perpetual inventory tracking of high risk drugs. In addition, the web application improves accuracy with multiple verification steps throughout the workflow, along with easy access to patient history and details. The unique database supports accuracy of the pharmacy process, thus reducing errors.

The system enables savings due to outscripting. A community pharmacy can outsource their pharmacist. In addition, the shared pharmacists model keeps costs down and doors open at the community pharmacy level. The system also provides the possibility for after hour and emergency community pharmacy care services. Savings are also provided by the efficiency of the pharmacy dispensing workflow system e.g. pulling stored patient information and history, stock prescription drug images, potential prescription drug interactions and allergies, along with potential prescription drug duplicates and therapies from preloaded databases. Because this telepharmacy system enables community pharmacies to share pharmacist expenses, it results in reduced labor expenses.

In broad embodiment, the present invention is a comprehensive and controlled web-based system to provide pharmaceutical care and medications to multiple retail or remote pharmacies via supervision and verification by pharmacists of non-pharmacists at remote sites; and a method to ensure safety and accuracy, and to reduce expense.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to. The invention has been described so as to enable one of ordinary skill in the art to practice the claimed invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What I claim is:

1. A web-enabled system for remote provision of services related to pharmacy ordering comprising at least one computer configured to:
a) accept patient data and prescription data;
b) accept patient-specific images related to said prescription;
c) retrieve information from one or more databases comprising information about drug interactions with said prescription, side effects of said prescription, directions for use of said prescription, and a plurality of images each associated with at least one identifier of the prescription;
d) form a patient data set comprising said accepted patient and prescription data and said retrieved information and images; and
e) facilitate communications between a patient and a remote pharmacist regarding at least some of the patient data set.

2. The system of claim 1 further configured to present to said remote pharmacist on at least one screen at least some of said patient data set.

3. The system of claim 2 wherein said at least some of said patient data set comprises information regarding any one of the group consisting of: drug interactions, drug side effects, drug usage.

4. The system of claim 3 further configured to present to said patient at least a portion of the at least some of said patient data set presented to said remote pharmacist.

5. The system of claim 4 further configured to electronically accept a confirmation from said patient of receipt of said at least some of said patient data set.

6. The system of claim 1 wherein said communications between said patient and the remote pharmacist comprises a video link.

7. The system of claim 6 wherein said communications between said patient and the remote pharmacist further comprises affirmative confirmation by patient of receipt of at least some portion of information retrieved.

8. A method for remote provision of pharmacy ordering services comprising a) a first location b) a competent review of an electronically presented plurality of data related to a prescription performed at said first location, c) a second location remote from said first location, d) delivery of at least a portion of said electronically presented plurality of data to said second location, e) an electronic confirmation of delivery comprising an electronically transmitted indicator of affirmation of understanding of said at least a portion of said data delivered to said second location.

9. The method of claim 8 wherein said competent review is performed by a licensed pharmacist.

10. The method of claim 9 wherein said plurality of data related to a prescription comprises patient data, prescription data, and at least one image of a drug dispensed in accordance with said prescription data.

11. The method of claim 10 wherein said electronic confirmation is provided by a patient through an electronic device.

12. The method of claim 9 wherein said licensed pharmacist is connected with a patient at the second location through a video link.
